(19) United States
(12) Patent Application Publication
(10) Pub. No.: US 2006/0164970 A1
(43) Pub. Date: Jul. 27, 2006

(54) Transmitter and receiver in DBLAST system

(75) Inventors: Kyu-Ha Lee, Seoul (KR); Sung-Hun Jung, Seongnam-si (KR); Dae-Sik Hong, Seoul (KR); Eun-Seok Ko, Seoul (KR); Jae-Hee Cho, Seoul (KR)

Correspondence Address: DILWORTH & BARRESE, LLP, 333 EARLE OVINGTON BLVD., UNIONDALE, NY, 11553, US

(73) Assignees: SAMSUNG THALES CO., LTD., Gumi-shi (KR); YONSEI UNIVERSITY, Seoul (KR)

(21) Appl. No.: 11/063,125

(22) Filed: Feb. 22, 2005

(30) Foreign Application Priority Data
Jan. 27, 2005 (KR) 7559/2005

(51) Int. Cl. H04J 11/00; H04J 3/02

(52) U.S. Cl. 370/208; 370/537

(57) ABSTRACT

A transmitter of a Diagonal Bell Laboratories Layered Space-Time (DBLAST) system includes an interleaver for performing interleaving for all sub-streams in a stream of a transmission signal, thereby generating an interleaved signal, a symbol repeater for generating a reverse-arranged signal rearranged in a reverse order to the interleaved signal, and a DBLAST transmit unit for transmitting the interleaved signal and the reverse-arranged signal through multiple transmit antennas. A receiver of a DBLAST system includes a DBLAST receive unit for receiving signals through multiple transmit antennas, a repeating symbol combiner for generating a combined signal; a deinterleaver for generating a deinterleaved signal; and a decoder for decoding the deinterleaved signal.

### PRIORITY

This application claims priority to an application entitled “Transmitter and Receiver in DBLAST System” filed in the Korean Industrial Property Office on Jan. 27, 2005 and assigned Serial No. 2005-007559, the contents of which are incorporated herein by reference.

### BACKGROUND OF THE INVENTION

1. Field of the Invention

The present invention relates to a Diagonal Bell Laboratories Layered Space-Time (DBLAST) system, and more particularly to a transmitter and a receiver in DBLAST system for improving error correction performance.

2. Description of the Related Art

The DBLAST system is a system which can improve transmission efficiency by employing multiple transmit/receive antennas and can be easily used with existing error correction codes. Therefore, the DBLAST system has gained recognition as a next-generation ultra high-speed transmission system.

When a transmission side of the DBLAST system simultaneously transmits different information signals through multiple transmit antennas, the multiple transmit antennas are used in a sequentially circulating order to radiate the information signals, so that the signals are transmitted in a diagonal direction. A reception side employs a nulling scheme and a canceling scheme in order to separate the signals transmitted from the multiple transmit antennas of the transmission side.

Canceling is a process in which restored signals are eliminated from the signals received at the reception side, that is, from the signals simultaneously transmitted from the multiple transmit antennas of the transmission side. The elimination of the restored signals reduces interference between the received signals, thereby improving the signal-to-noise ratio. Nulling is a process of restoring predetermined reception signals from among the reception signals remaining after the canceling. Here, the restored signals serve as signals for the next canceling. Nulling is used because the canceling cannot eliminate all interference signals, that is, signals transmitted from other transmit antennas. The reception side can restore the received DBLAST signals by repeatedly performing the canceling and nulling.

In the meantime, different information signals are transmitted by the multiple transmit antennas in a sequentially circulating order in the transmission side of the DBLAST system as described above. Therefore, the separation of the transmitted signals by using the nulling and canceling in the reception side may cause the received signals to have step-type signal-to-noise ratio. That is to say, it becomes highly possible that concatenation error may occur at the portion corresponding to the lowest signal-to-noise ratio. This problem will be discussed hereinafter in more detail with reference to FIGS. 1 through 5.

FIG. 1 is a block diagram of a conventional DBLAST system.

A transmitter 100 of the DBLAST system includes a channel encoder 110, an interleaver 120, a modulator 130 and a DBLAST transmit unit 140. The receiver 200 of the DBLAST system includes a channel decoder 210, a deinterleaver 220, a demodulator 230 and a DBLAST receive unit 240.

A DBLAST frame includes τ substreams which are independently coded, interleaved and modulated. Herein, τ corresponds to the number of transmit or receive antennas included in the DBLAST transmit unit 140 or the DBLAST receive unit 240. In a typical DBLAST system, the number of transmit antennas is equal to the number of receive antennas.

In operation of the transmitter 100, the channel encoder 110 channel-codes an input signal Iτ and outputs a channel-coded signal Cτ. The interleaver 120 interleaves the channel-coded signal Cτ and outputs an interleaved signal Lτ. The modulator 130 modulates the interleaved signal Lτ according to a predetermined modulation scheme and outputs a modulated signal Mτ. When the modulated signal Mτ obtained through channel-coding, interleaving and modulating is input to the DBLAST transmit unit 140, the DBLAST transmit unit 140 converts the input signal Mτ into a transmit signal St and transmits the transmit signal St by using the transmit antennas in turn, as shown according to time and the number of antennas (as illustrated in FIG. 2).

FIG. 2 illustrates a frame structure of a transmit signal transmitted by the DBLAST transmit unit in FIG. 1.

The frame structure shown in FIG. 2 is based on an assumption that τ (i.e., the number of transmit antennas) is 4, in which the DBLAST transmit unit 140 of the transmitter 100 transmits sub-sequences Mi (i=1, 2, 3, or 4) by using the four transmit antennas while distributing the sub-sequences diagonally in space and time.

The DBLAST transmit unit 140 transmits the first n_{b} symbols M_{1,1} to M_{1,nb} of the first sub-sequence M₁ through the τ^{th} transmit antenna at a first time slot TS₁ and transmits the second n_{b} symbols M_{1,nb+1} to M_{1,2nb} of the sub-sequence M₁ through the (τ−1)^{th} transmit antenna at a second time slot TS₂. In the same manner, DBLAST transmit unit 140 transmits the last n_{b} symbols M_{1,3nb+1} to M_{1,4nb} of the sub-sequence M₁ through the first transmit antenna at a fourth time slot TS₄. That is, the symbols M_{1,1} to M_{1,4nb} of the sub-sequence M₁ are transmitted by the four transmit antennas while being distributed diagonally in space and time, so that the symbols are transmitted in a diagonal direction as shown in FIG. 2.

Further, the DBLAST transmit unit 140 transmits the second sub-sequence M₂ from the second time slot TS₂. Specifically, the DBLAST transmit unit 140 transmits the first n_{b} symbols M_{2,1} to M_{2,nb} of the sub-sequence M₂ through the τ^{th} transmit antenna at the second time slot TS₂ and transmits the second n_{b} symbols M_{2,nb+1} to M_{2,2nb} of the sub-sequence M₂ through the (τ−1)^{th} transmit antenna at the third time slot TS₃. In the same manner, DBLAST transmit unit 140 transmits the last n_{b} symbols M_{2,3nb+1} to M_{2,4nb} of the sub-sequence M₂ through the first transmit antenna at a fifth time slot TS₅ (not shown).

The DBLAST transmit unit 140 transmits the third sub-sequence M₃ and the fourth sub-sequence M₄ in the same manner as described above, which distributes the symbols according to both time and space. The only difference is that the DBLAST transmit unit 140 transmits the third sub-sequence M₃ from the third time slot TS₃ and the fourth sub-sequence M₄ from the fourth time slot TS₄. Herein, the DBLAST transmit unit 140 uses the same frequency and the same bandwidth to transmit the signal St.

The transmit signal St is transmitted via a transmit channel and is converted to a signal Ŝ t through mixing of Gaussian noise Vt into the transmit signal St, and the receiver 200 receives the signal Ŝ t through the receive antennas of the DBLAST receive unit 240.

However, since the transmitter 100 simultaneously transmits the signal Ŝ t through the transmit antennas of the DBLAST transmit unit 140, a receiver of a typical communication system cannot separate the simultaneously transmitted signals. Therefore, the DBLAST system separates and restores the received signals Ŝ t by using the nulling scheme and the canceling scheme, which will be described hereinafter in detail with reference to FIGS. 3 and 4.

FIG. 3 illustrates a frame structure for describing the canceling of a signal received by the DBLAST receive unit of FIG. 1.

The frame structure shown in FIG. 3 is also based on an assumption that τ (i.e., the number of receive antennas which in the example illustrated above is equal to 4) is equal to the number of transmit antennas. Since the symbols of the received sub-stream are located in the diagonal direction, some time slots contain (τ−1) interference signals from other receive antennas. Herein, the interference signals may be classified into interference signals located above the diagonal line and interference signals located under the diagonal line. The DBLAST receive unit 240 of the receiver 200 cancels the interference signals under the diagonal line by using the received signal St of the current slot estimated in advance by the received signal obtained in the previous time slot and a channel response H. The DBLAST receive unit 240 obtains the interference signals above the diagonal line by performing nulling by using the signals obtained through the canceling.

As shown, since only the interference signals under the diagonal line exist in the first time slot TS₁, the DBLAST receive unit 240 obtains the first nb symbols of the transmitted sub-stream S₁ corresponding to the sub-sequence M₁ by performing the canceling. Since both the interference signals under the diagonal line and the interference signals above the diagonal line exist in the second and third time slots TS₂ and TS₃, the DBLAST receive unit 240 obtains the second and third n_{b} symbols of the transmitted sub-stream S₁ by performing the canceling and the nulling. Since only the interference signals above the diagonal line exist in the fourth time slot TS₄, the DBLAST receive unit 240 obtains the fourth n_{b} symbols of the transmitted sub-stream S₁ by performing the nulling.

FIG. 4 illustrates a frame structure for describing the nulling of a signal received by the DBLAST receive unit of FIG. 1.

Since only interference signals to be eliminated by nulling above the diagonal line exist in all of the first to fourth time slots TS₁ to TS₄ shown in FIG. 4, the DBLAST receive unit 240 obtains n_{b} symbols of the transmitted sub-stream S₁ by performing the nulling in each time slot.

The DBLAST receive unit 240 restores the DBLAST signal by repeatedly performing the canceling and the nulling as described above. However, since the DBLAST signal is transmitted in the diagonal direction, the signal received later contains more interference signals than the signal received earlier. Therefore, the received DBLAST signals have a step-type signal-to-noise ratio characteristic in which the signal received later has a signal-to-noise ratio smaller than a signal-to-noise ratio of the signal received earlier. Due to this step-type signal-to-noise ratio characteristic, some signals having a low signal-to-noise ratio may contain noise stronger than the pure signal. Therefore, a concatenation error may occur in some signals having a low signal-to-noise ratio, thereby degrading the error correction performance of the system.

In order to improve the step-type signal-to-noise ratio characteristic of the DBLAST system, G. Foschini has proposed an interleaving and deinterleaving scheme which is applied to sub-streams having signal-to-noise ratios complementary to each other. The proposed interleaving and deinterleaving scheme will be described hereinafter with reference to FIGS. 5 and 6, based on an assumption that the number of transmit antennas and the number of receive antennas are each equal to 4.

FIG. 5 illustrates a structure for describing a process of interleaving by the interleaver of FIG. 1.

On the assumption that the DBLAST transmit unit 140 of the transmitter 100 includes four antennas, the transmission stream has a length corresponding to 16 symbols. Therefore, the interleaver 120 divides the transmission stream into four sub-streams and performs the interleaving, thereby arranging the sub-streams in the diagonal direction as shown.

When the receiver 200 has restored the interleaved transmission stream by using the canceling and the nulling, the transmission stream has a structure as shown in the lower side of FIG. 6 which illustrates a structure for describing a process of deinterleaving by the deinterleaver of FIG. 1.

In the transmission stream, which is a DBLAST signal having the step-type signal-to-noise ratio characteristic, the sub-streams are arranged in an order in proportion to the magnitude of the signal-to-noise ratios. Then, the deinterleaver 220 of the receiver 200 deinterleaves the transmission stream, so that the transmission stream has a structure as shown in the upper side of FIG. 6. It should be noted that, in the structure shown, the likelihood of transmission errors can be decreased by mixing concatenation errors which can be caused by step-wise SNR (signal to noise ratio) characteristics of DBLAST signals. Therefore, it is important how the concatenation errors are mixed, because as the types of channels increase, so does the extent of the concatenation error mix. Thus, it is desirable to implement an interleaving technique using all types of channels. Then, the deinterleaver 220 inputs the transmission stream having the construction as described above to the demodulator 230 which is a maximum likelyhood decoder.

Since the interleaving and deinterleaving scheme as described above is applied to only two sub-streams having signal-to-noise ratios complementary to each other, only two channel responses (where channel responses refers to equivalent responses of a channel of a transmission signal after decoding according to a DBLAST system) can be used from among four different channel responses even when the system includes four transmit antennas and four receive antennas. As a result, the interleaving and deinterleaving scheme fails to use all channel responses of the DBLAST multiple transmit/receive antennas. Additionally, the interleaving and deinterleaving scheme is susceptible to concatenation errors and degrading of the performance of the maximum likelyhood decoder which can degrade the bit error rate performance of the DBLAST system.

### SUMMARY OF THE INVENTION

Accordingly, the present invention has been made to solve the above-mentioned problems occurring in the prior art, and an object of the present invention is to provide a transmitter and a receiver of a DBLAST system, which use a signal repetition technique employing interleaving and deinterleaving using all sub-streams.

In order to accomplish this object, there is provided a transmitter of a DBLAST system, which includes an interleaver for performing interleaving for all sub-streams in a stream of a transmission signal, thereby generating an interleaved signal; a symbol repeater for generating a reverse-arranged signal rearranged in a reverse order with respect to the interleaved signal; and a DBLAST transmit unit for transmitting the interleaved signal and the reverse-arranged signal through multiple transmit antennas.

In accordance with another aspect of the present invention, there is provided a receiver of a DBLAST system, which includes a DBLAST receive unit for receiving signals through multiple transmit antennas, the signals having been transmitted according to a DBLAST scheme; a repeating symbol combiner for combining the signals received by the DBLAST receive unit, thereby generating a combined signal; a deinterleaver for performing deinterleaving for all sub-streams in a stream of the combined signal, thereby generating a deinterleaved signal; and a decoder for decoding the deinterleaved signal.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a conventional DBLAST system;

FIG. 2 illustrates a frame structure of a transmit signal transmitted by the DBLAST transmit unit in FIG. 1;

FIG. 3 illustrates a frame structure for describing the canceling of a signal received by the DBLAST receive unit of FIG. 1;

FIG. 4 illustrates a frame structure for describing the nulling of a signal received by the DBLAST receive unit of FIG. 1;

FIG. 5 illustrates a structure for describing a process of interleaving by the interleaver of FIG. 1;

FIG. 6 illustrates a structure for describing a process of deinterleaving by the deinterleaver of FIG. 1;

FIG. 7 is a block diagram of a DBLAST transmitter for performing interleaving according to a preferred embodiment of the present invention;

FIG. 8 is a block diagram of the interleaver according to the preferred embodiment of the present invention;

FIG. 9 illustrates a frame structure for describing the interleaving pattern according the preferred embodiment of the present invention;

FIG. 10 illustrates a structure of a BLAST signal repeatedly transmitted using different frequencies by the signal repetition technique;

FIG. 11 is a block diagram of the symbol repeater in FIG. 7;

FIG. 12 is a block diagram of a DBLAST receiver which performs interleaving according to a preferred embodiment of the present invention;

FIG. 13 is a block diagram of the repeating symbol combiner of FIG. 12;

FIG. 14 illustrates a structure for describing a process of combining repeating signals according to a signal repetition technique at the reception side and signal-to-noise ratios of the combined signal;

FIG. 15 illustrates a structure for describing a process of deinterleaving according to a preferred embodiment of the present invention; and

FIG. 16 is a block diagram of a deinterleaver according to a preferred embodiment of the present invention.

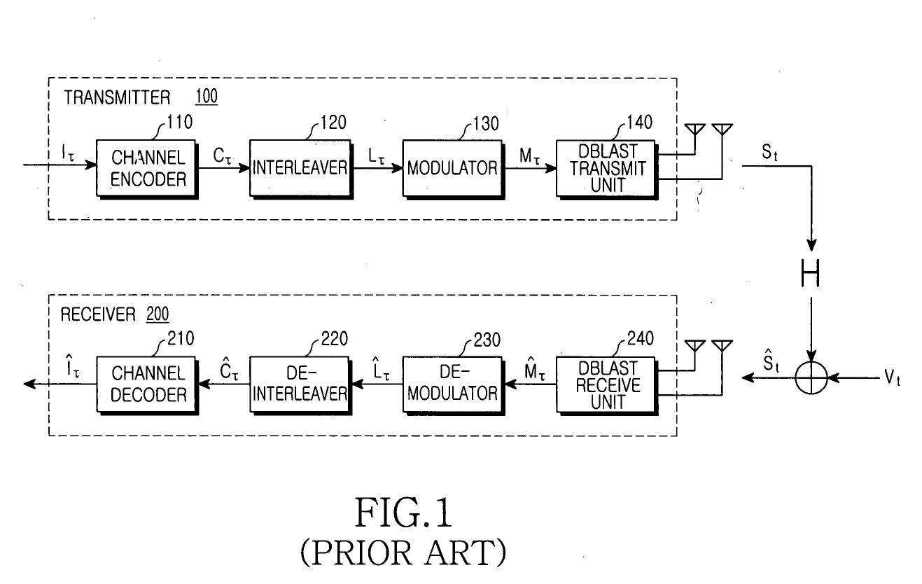

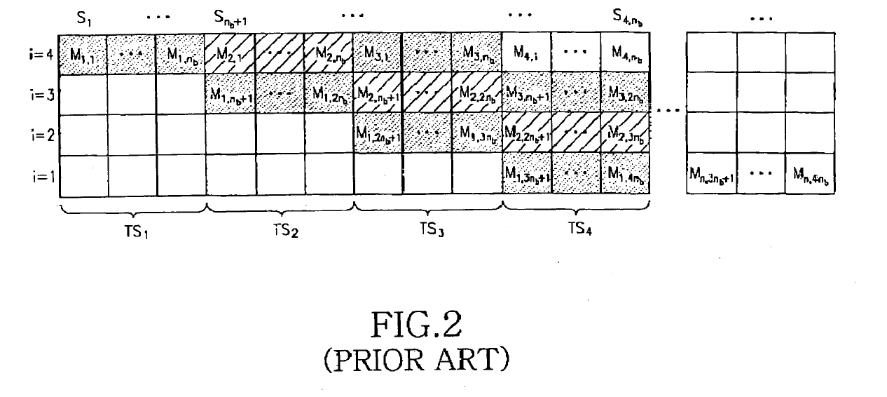

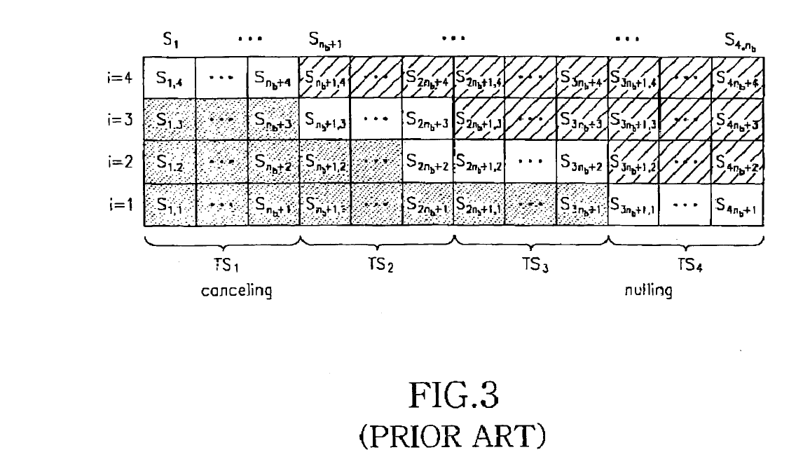

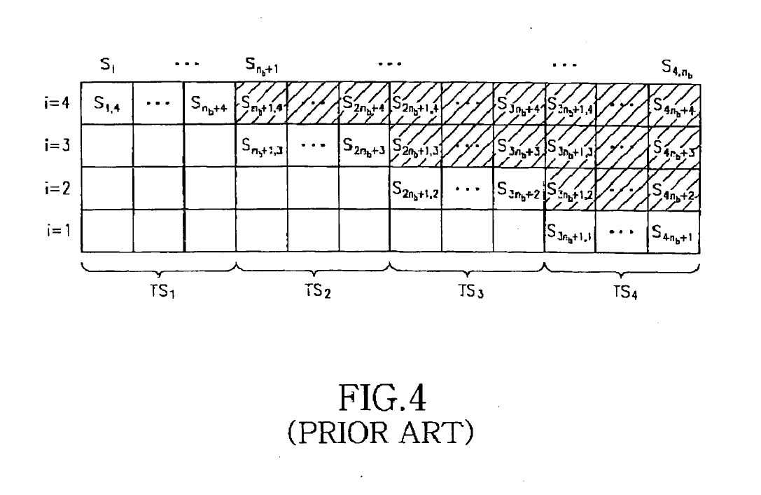

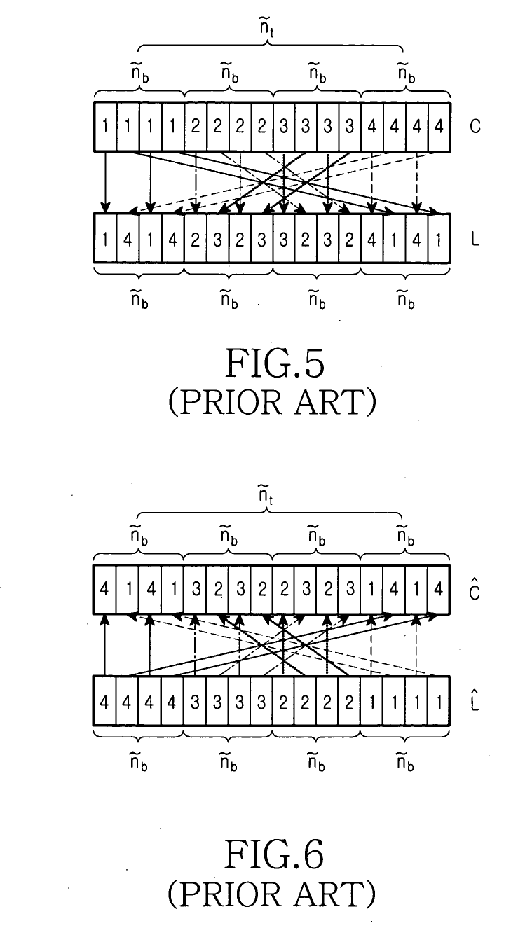

### DETAILED DESCRIPTION OF THE PREFERRED EMBODIMENT

Hereinafter, preferred embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention unclear.

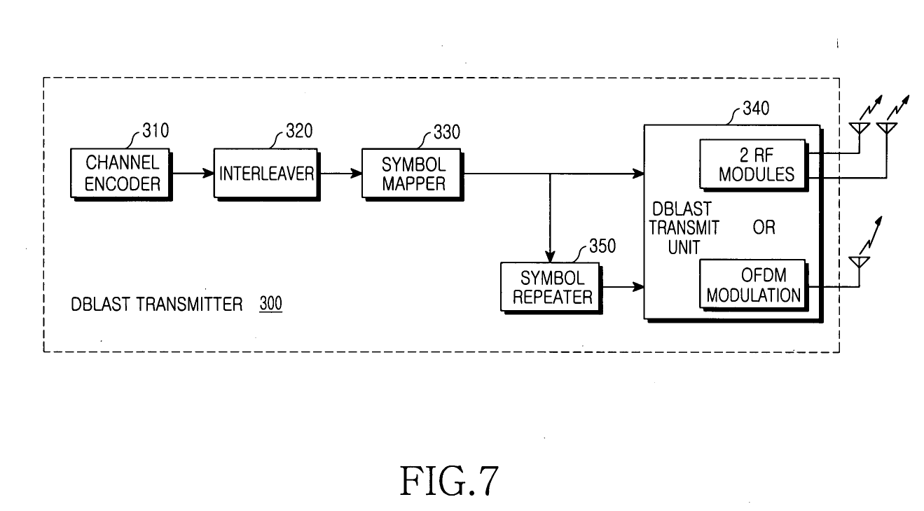

FIG. 7 is a block diagram of a DBLAST transmitter for performing interleaving according to a preferred embodiment of the present invention.

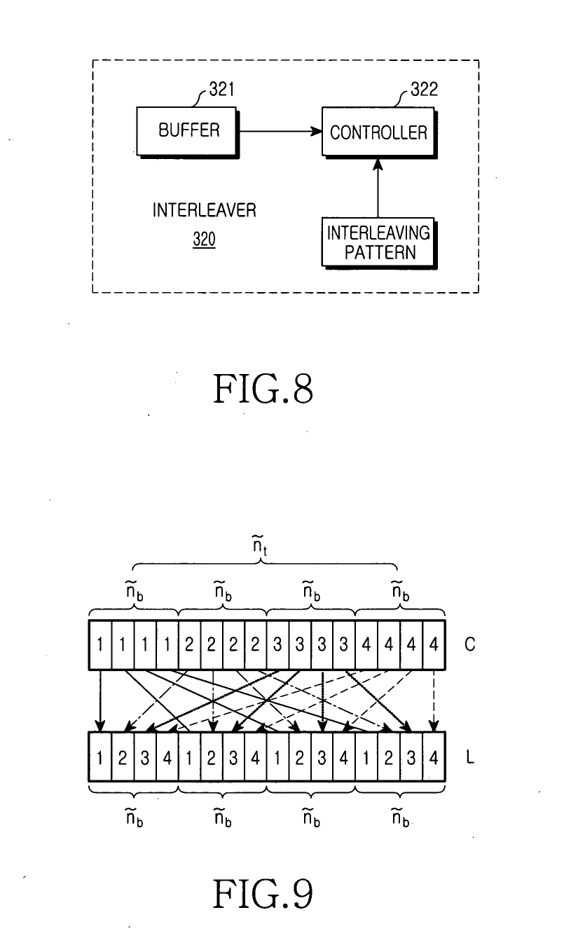

Upon receiving transmission data, a channel coder 310 of the DBLAST transmitter 300 performs channel coding for the data and inputs channel-coded data to an interleaver 320 according to a preferred embodiment of the present invention. Hereinafter, the interleaver 320 will be described in detail with reference to FIG. 8.

FIG. 8 is a block diagram of the interleaver according to the preferred embodiment of the present invention.

The channel-coded data input from the channel coder 310 is stored in a buffer 321 of the interleaver 320, and a controller 322 interleaves the channel-coded data stored in the buffer 321 following an interleaving pattern programmed according a preferred embodiment of the present invention. Hereinafter, on an assumption that the transmitter includes four transmit antennas (i.e. T=4), a process of interleaving by the controller 322 following the interleaving pattern according the preferred embodiment of the present invention will be described in detail with reference to FIG. 9.

FIG. 9 illustrates a frame structure for describing the interleaving pattern according the preferred embodiment of the present invention.

On the assumption that the transmitter 300 includes four antennas, the transmission stream has a length corresponding to 16 symbols. Therefore, the controller 322 of the interleaver 320 divides the transmission stream into four sub-streams and performs the interleaving for the divided sub-streams. Here, the controller 322 mixes all the sub-streams following the interleaving pattern according the preferred embodiment of the present invention. When the interleaving is performed for all the sub-streams as opposed to the prior art in which only two sub-streams are interleaved, the variety of channels increases so that the concatenation errors are randomized and thereby reduced. That is, the interleaving pattern according the preferred embodiment of the present invention can prevent generation of concatenation errors which transmitters using prior art systems and methods are more likely to suffer from. After interleaving is performed the controller 322 inputs the interleaved transmission stream as described above to the symbol mapper 330 as shown in FIG. 7.

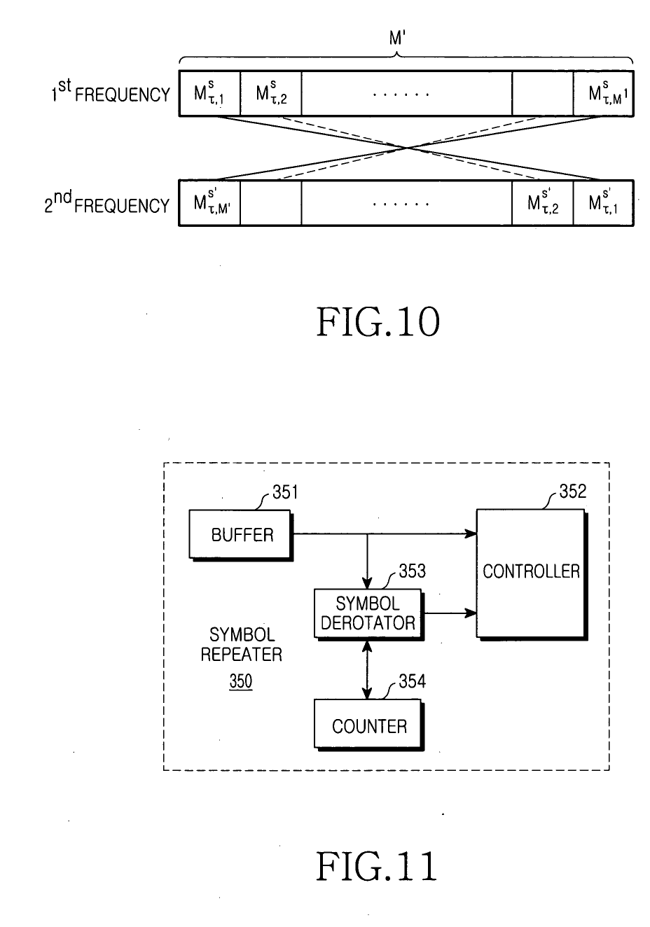

The symbol mapper 330 constructs transmissible symbols by binding bits of the transmission stream interleaved in the interleaver 320 and inputs the transmissible symbols to the DBLAST transmit unit 340 and the symbol repeater 350. The symbol repeater 350 is a unit for performing a signal repetition technique proposed in order to solve the problem of the step-type signal-to-noise ratio characteristic of the DBLAST system. The signal repetition technique is a technique of repeatedly transmitting the same signal using different frequencies, which will be described in detail with reference to FIG. 10.

FIG. 10 illustrates a structure of a signal repeatedly transmitted using different frequencies by the signal repetition technique.

Referring to FIG. 10, the signal is first transmitted using a first frequency by a typical transmission method, and the same signal is then transmitted in a reversed order using a second frequency. As a result, the portion having a low signal-to-noise ratio due to large influence by interference signals in the signal transmitted using the first frequency has a high signal-to-noise ratio due to small influence by interference signals when transmitted using the second frequency. Therefore, combining the signals of the first frequency and the second frequency can achieve a signal having a constant signal-to-noise ratio at the reception side, thereby minimizing the concatenation error due to the step-type signal-to-noise ratio in the DBLAST system. Hereinafter, the symbol repeater 350 which performs the process of reversing the order of a signal in order to perform the signal repetition technique will be described in detail with reference to FIG. 11.

FIG. 11 is a block diagram of the symbol repeater in FIG. 7. A signal processed by the symbol mapper 330 is stored in a buffer 351 of the symbol repeater 350, and then the symbol repeater 350 inputs the signal stored in the buffer 351 to a controller 352 and a symbol derotator 353. The symbol derotator 353 rearranges the input signal in a reverse order based on count values provided by the counter 354 and inputs the rearranged signal to the controller 352. The controller 352 receives the signal input directly from the buffer 351 and the rearranged signal from the symbol derotator 353 and inputs them to the DBLAST transmit unit 340.

The DBLAST transmit unit 340 receives the signals from the symbol mapper 330 and the symbol repeater 350 and transmits them using the multiple transmit antennas diagonally in space and time. Here, the DBLAST transmit unit 340 must transmit the two signals from the symbol mapper 330 and the symbol repeater 350 using two frequencies. This requires two Radio Frequency (RF) modules for a single carrier system but in alternative embodiments, can be realized by only one RF module in a multi-carrier system. That is, an Orthogonal Frequency Division Multiplexing (OFDM) system uses different sub-carriers in order to perform the signal repetition technique and sets the sub-carriers to have bandwidths larger than a coherence bandwidth of a channel.

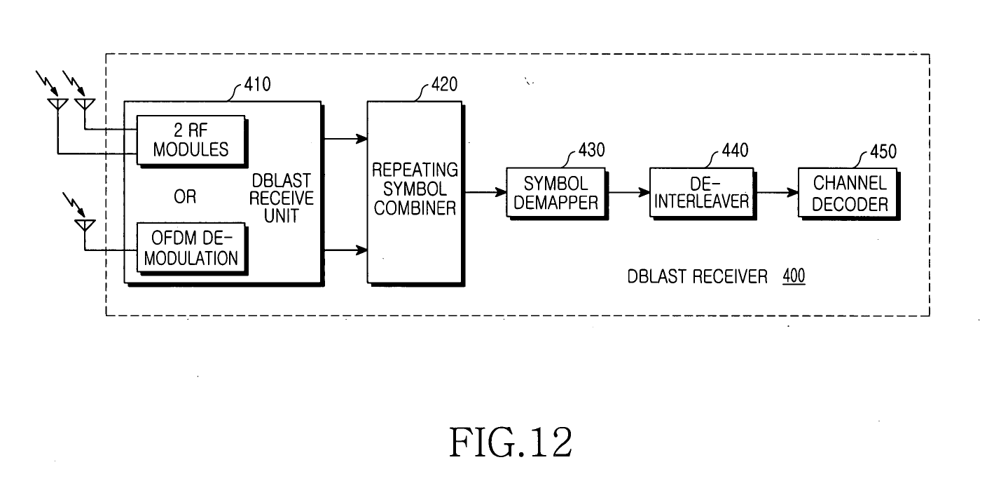

Hereinafter, a DBLAST receiver which receives the two signals from the DBLAST transmit unit 340 and interleaves the two signals' according to a preferred embodiment of the present invention will be described in detail with reference to FIG. 12.

FIG. 12 is a block diagram of a DBLAST receiver which performs interleaving according to a preferred embodiment of the present invention.

A DBLAST receive unit 410 of the DBLAST receiver 400 receives the two signals which were transmitted using the two frequencies from the transmission side based on the characteristics of the two transmitted frequencies. Here, when the transmission side transmits the two signals according to an OFDM modulation scheme, the DBLAST receive unit 410 also receives the two signals according to an OFDM demodulation scheme. Likewise other transmission schemes are possible.

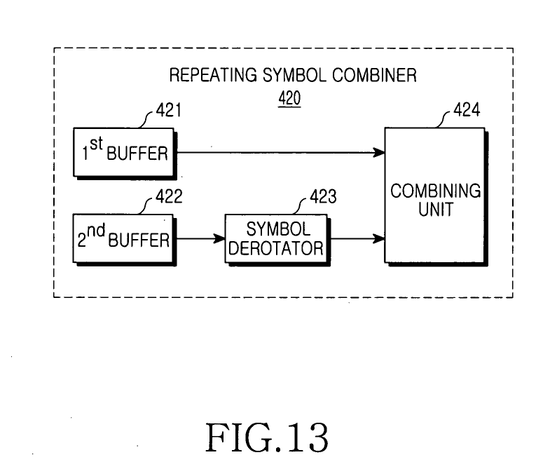

A repeating symbol combiner 420 receives the two signals from the DBLAST receive unit 410 and combines the two signals in a crossing manner, thereby outputting a reception signal having a constant signal-to-noise ratio, which will be described in detail with reference to FIG. 13.

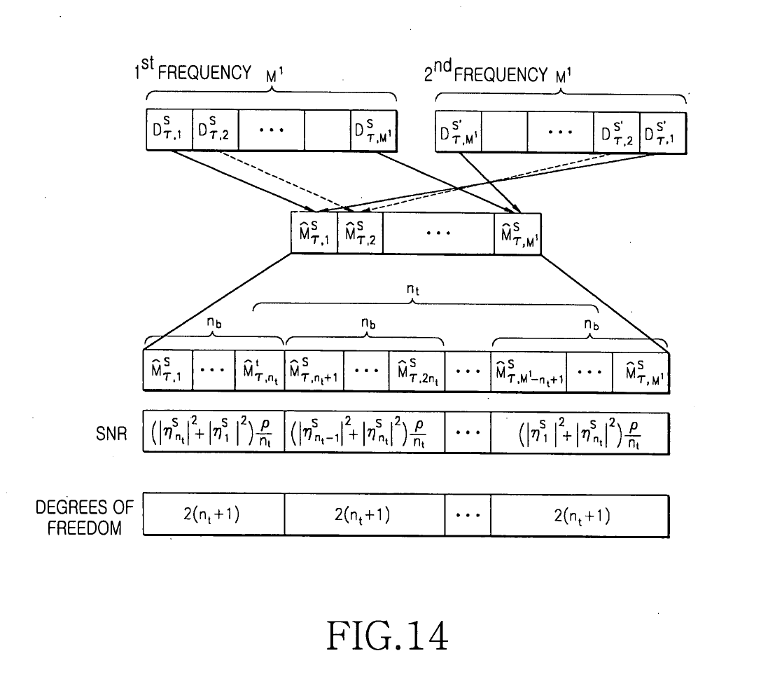

FIG. 13 is a block diagram of the repeating symbol combiner of FIG. 12. The two signals received by the DBLAST receive unit 410 of FIG. 12 are stored in the first buffer 421 and the second buffer 422, and the repeating symbol combiner 420 inputs the signal stored in the second buffer 422 to the symbol derotator 423. The symbol derotator 423 performs a similar operation as that of the symbol derotator 353 of FIG. 11, and the signal input to the symbol derotator 423 is the signal output from the symbol derotator 353 of FIG. 11. Therefore, the signal output from the symbol derotator 423 is equal to the signal input to the symbol derotator 353 of FIG. 11. The signals output from the first buffer 421 and the symbol derotator 423 are combined with each other by a combining unit 424 and the combined signal is then input to a symbol demapper 430. Hereinafter, a process in which the repeating symbol combiner 420 combines the two signals to obtain a signal having a constant signal-to-noise ratio will be described in detail with reference to FIG. 14.

FIG. 14 illustrates a structure for describing a process of combining repeating signals according to a signal repetition technique at the reception side and signal-to-noise ratios of the combined signal.

There exist 0, 1, . . . , (τ−1) interference signals in the first time slot TS₁ to τ^{th} time slot TSτ, respectively, (included a signal D after performing nulling and canceling). Therefore, each of the two signals has signal ratios of |nₙ_{ₜ}^{S}|²ρ/nₜ |nₙ_{ₜ}₋₁^{S}|²ρ/nₜ, . . . , and |nₙ_{₁}^{S}|²ρ/nₜ and degrees of freedom of 2 nₜ, 2(nₜ−1), . . . , and 2. The combined signal obtained by cross-combining the two signals are modeled to have a Chi-square distribution, in which signal ratios are (|nₙ_{ₜ}^{S}|²+|n₁^{S}|²)ρ/nₜ, (|nₙ_{ₜ}₋₁^{S}|²+|nₜ^{S}|²)ρ/nₜ, . . . , and (|n₁^{S}|²+|nₜ^{S}|²)ρ/nₜ and degrees of freedom are 2(nₜ+1), 2(nₜ+1), . . . , and 2(nₜ+1).

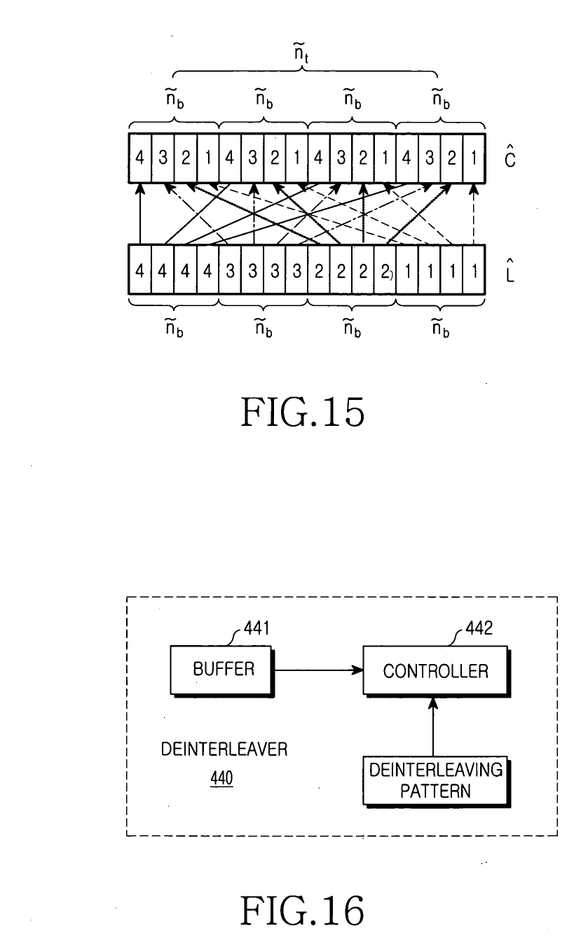

Referring again to FIG. 12, when the signal combined by the repeating symbol combiner 420 has been restored by the symbol demapper 430, the signal has a stream structure as shown in the lower part of FIG. 15. The symbol demapper 430 inputs the restored stream to a deinterleaver 440 according to a preferred embodiment of the present invention, which will be described in detail with reference to FIG. 16.

FIG. 16 is a block diagram of a deinterleaver according to a preferred embodiment of the present invention.

The stream restored by the symbol demapper 430 is stored in a buffer 441 of the deinterleaver 440 and a controller 442 deinterleaves the stream stored in the buffer 441 according to a deinterleaving pattern programmed according to the preferred embodiment of the present invention. Then, the stream structure as shown in the lower part of FIG. 15 is converted to the stream structure as shown in the upper part of FIG. 15 through the deinterleaving of all sub-streams in the entire stream. The stream having the stream structure as shown in the upper part of FIG. 15 is then input to a channel decoder 450, and the channel decoder 450 generates final information bits.

According to the present invention as described above, interleaving and deinterleaving are performed for all sub-streams in a stream of a DBLAST signal, so that the variety of channels increases and concatenation errors are randomized and therefore reduced or minimized.

Further, the present invention enables the reception side to obtain a signal having improved signal-to-noise ratio through the reduction of the concatenation error, thereby improving an error correction performance of the system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A transmitter of a DBLAST (Diagonal Bell Laboratories Layered Space-Time) system, the transmitter comprising:
an interleaver for performing interleaving for all sub-streams in a stream of a transmission signal, thereby generating an interleaved signal;
a symbol repeater for generating a reverse-arranged signal rearranged in a reverse order with respect to the interleaved signal; and
a DBLAST transmit unit for transmitting the interleaved signal and the reverse-arranged signal through multiple transmit antennas.

2. The transmitter of a DBLAST system as claimed in claim 1, wherein the interleaver comprises:
a buffer for storing the transmission signal in a channel-coded state; and
a controller for performing the interleaving for all sub-streams in the stream of the transmission signal stored in the buffer.

3. The transmitter of a DBLAST system as claimed in claim 1, wherein the DBLAST transmit unit uses different frequencies for transmitting the interleaved signal and the reverse-arranged signal.

4. The transmitter of a DBLAST system as claimed in claim 1, wherein the DBLAST transmit unit uses an OFDM (Orthogonal Frequency Division Multiplexing) scheme for transmitting the interleaved signal and the reverse-arranged signal.

5. A receiver of a DBLAST (Diagonal Bell Laboratories Layered Space-Time) system, the receiver comprising:
a DBLAST receive unit for receiving signals through multiple transmit antennas, the signals having been transmitted according to a DBLAST scheme;
a repeating symbol combiner for combining the signals received by the DBLAST receive unit, thereby generating a combined signal;
a deinterleaver for performing deinterleaving for all sub-streams in a stream of the combined signal, thereby generating a deinterleaved signal; and
a decoder for decoding the deinterleaved signal.

6. The receiver of a DBLAST system as claimed in claim 5, wherein the deinterleaver comprises:
a buffer for storing the combined signal in a restored state; and
a controller for performing the deinterleaving for all sub-streams in the stream of the combined signal stored in the buffer.
